(19) United States
(12) Patent Application Publication
(10) Pub. No.: US 2007/0061522 A1
(43) Pub. Date: Mar. 15, 2007

(54) Storage device for storing different data formats

(75) Inventor: Jan Vink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,461

(22) PCT Filed: Jun. 21, 2004
(86) PCT No.: PCT/IB04/50949

§ 371 Date: Dec. 20, 2005

(30) Foreign Application Priority Data
Jun. 25, 2003 (EP) 03101889.8

(51) Int. Cl. G06F 13/00; G06F 12/16

(52) U.S. Cl. 711/154; 711/162

(57) ABSTRACT

Storage devices (2) receiving first data pieces having first formats and supplying second data pieces having second formats different from the first formats, store a set of first data pieces and a subset of second data pieces in a storage medium (23). A processor (20) searches the storage medium (23) for a predefined second data piece. In response to a positive search result, the predefined second data piece is supplied to a reproduction device (3) for being reproduced without any transcoding being necessary, to save processing capacity and power consumption. In response to a negative search result, due to having stored only a subset of second data pieces in the storage medium (23), to save storage capacity, a corresponding first data piece is read out from the storage medium (23) and a transcoder (22) transcodes this corresponding first data piece into the predefined second data piece, after which the predefined second data piece is supplied to the reproduction device (3).

The invention relates to a storage device for storing data pieces, to a system, to a processor, to a method and to a processor program product.

Examples of storage devices are audio recorders or audio servers and video recorders or video servers, with the data pieces then being pieces of audio or pieces of video.

A prior art storage device is known from U.S. Pat. No. 6,141,447, column 1 lines 10-25, which discloses, inter alia, non-transcoder technology: a video server is used for storing multiple copies of the same video sequence encoded at different bit rates, resolutions or formats, to be able to deliver video bit streams using different bit rates, resolutions or formats depending on factors such as network congestion, decoder capability or requests from end users. This requires large amounts of storage capacity. To overcome this problem, in U.S. Pat. No. 6,141,447, column 1 lines 25-35, transcoder technology, inter alia, is introduced: a transcoder comprises a decoder for decoding a high bit rate compressed video bit stream for producing a frame sequence of decoded video pixels, and comprises an encoder for encoding the decoded frame sequence using a lower bit rate and resolution for producing a low bit rate compressed video bit stream. This however requires much processing capacity and consumes much power.

Storage devices receiving first data pieces having a first format and supplying second data pieces having a second format different from the first format therefore have two options. Firstly, the storage devices may transcode each first data piece upon receival into the corresponding second data piece once and then store this second data piece, such that the second data piece can be supplied over and over again by making copies of it. The storing of these second data pieces, possibly in addition to storing the first data pieces, requires a large amount of storage capacity, especially in case the second data format requires more storage capacity than the first data format. Secondly, the storage devices may store each first data piece upon receival and then, upon request, transcode a predefined first data piece into the corresponding second data piece each time this corresponding second data piece is requested and then supply this corresponding second data piece. This requires much processing capacity and consumes much power.

The known storage device is disadvantageous, inter alia, due to either requiring relatively large amounts of storage capacity or requiring relatively much processing capacity and consuming relatively much power.

It is an object of the invention, inter alia, of providing a storage device which uses its storage capacity as well as its processing capacity relatively efficient.

Furthers objects of the invention are, inter alia, providing a system comprising a storage device which uses its storage capacity as well as its processing capacity relatively efficient, a processor for use in a storage device which uses its storage capacity as well as its processing capacity relatively efficient, and a method and a processor program product using a storage capacity as well as a processing capacity relatively efficient.

The storage device according to the invention for storing data pieces comprises
an input for receiving first data pieces having a first format;
a transcoder for transcoding a first data piece into a second data piece having a second format different from the first format;
a storage medium for storing a set of first data pieces and a subset of second data pieces; and
a processor for searching for a predefined second data piece stored in the storage medium and for, in response to a positive search result, supplying the predefined second data piece to a reproduction device and for, in response to a negative search result, controlling the transcoder for transcoding a corresponding first data piece into the predefined second data piece and supplying the predefined second data piece to the reproduction device.

According to the invention, a set of first data pieces is stored in the storage medium, and a subset of second data pieces is stored in the storage medium. This subset for example comprises a preferred part of the set. The processor searches the storage medium for a predefined second data piece. In response to a positive search result corresponding with having found the predefined second data piece, the predefined second data piece is supplied to the reproduction device without the transcoder being involved. As a result, processing capacity is saved, and less power is consumed. In response to a negative search result corresponding with not having found the predefined second data piece, a corresponding first data piece is read out from the storage medium and the transcoder is controlled for transcoding this corresponding first data piece into the predefined second data piece, after which the predefined second data piece is supplied to the reproduction device without being previously stored in the storage medium. In this case, storage capacity is saved. The storage device according to the invention therefore uses its storage capacity as well as its processing power relatively efficient.

It should be noted that the first and second format may comprise first and second bit rates, resolutions, encodings, standards etc. Further formats are not to be excluded.

A first embodiment of the storage device according to the invention is defined by the processor being arranged to delete second data pieces stored in the storage medium in dependence of data piece priorities. By storing a second data piece in the storage medium after the transcoder has transcoded a corresponding first data piece into the second data piece and giving each first or second data piece a data piece priority, as soon as more storage capacity is needed than is available and/or as soon as the necessary storage capacity for the second data pieces exceeds a predefined value, those second data pieces having the lower priorities can be deleted. As a result, the second data pieces having the higher priorities are available directly, without any transcoding being necessary, while the second data pieces having the lower priorities are available indirectly through transcoding corresponding first data pieces stored in the storage medium.

A second embodiment of the storage device according to the invention is defined by the data pieces being pieces of music, with the first data format corresponding with a first audio standard like for example MP3 (MPEG Audio Layer-3) WAV (wave), WMA (Windows Media Audio) etc. and with the second data format corresponding with a second audio standard like SBC (Sub Band Coding) etc. The first audio standard requires less storage capacity than the second audio standard. Therefore, the entire set of first data pieces, usually comprising all first data pieces, is stored, and only the subset of second data pieces, like for example the most popular second data pieces having the higher priorities, will be stored. A piece of audio for example comprises a (part of a) song or a (part of a) spoken text etc.

A third embodiment of the storage device according to the invention is defined by the reproduction device being coupled to the storage device via a wireless channel requiring data pieces to have the second data format. Such a wireless channel like for example Bluetooth allows the storage device and the reproduction device to be coupled wirelessly, thereby giving a user more freedom in his movements.

A fourth embodiment of the storage device according to the invention is defined by the storage device comprising an audio recorder like for example a hard disk drive recorder and the reproduction device comprising one or more loudspeakers like for example a (wireless or wired) headset. When recording first data pieces from the internet, the storage device does not need to be coupled to the reproduction device. When playing one or more predefined second data pieces, the storage device is coupled to the reproduction device for making it possible to reproduce these second data pieces.

Embodiments of the system according to the invention and of the processor according to the invention and of the method according to the invention and of the processor program product according to the invention correspond with the embodiments of the storage device according to the invention.

The invention is based upon an insight, inter alia, that non-transcoder technology requires relatively large amounts of storage capacity and transcoder technology requires relatively much processing capacity and consumes relatively much power, and is based upon a basic idea, inter alia, that all second data pieces do not need to be stored in the storage medium, just a set of first data pieces and a subset of second data pieces are to be stored, with the processor searching for a predefined second data piece and in case of not having found it activating the transcoder for transcoding a corresponding first data piece into this predefined second data piece.

The invention solves the problem, inter alia, of providing a storage device which uses its storage capacity as swell as its professing capacity relatively efficient, and is advantageous, inter alia, in that it has an increased battery life time compared to prior art devices using transcoders all the time, and in that it requires less storage capacity compared to prior art devices storing all first and second data pieces in parallel. Further, the storage device according to the invention offers an efficient audio interface between for example the internet and channels requiring a non-internet data format.

These and other aspects of the invention will be apparent from and elucidated with reference to the embodiments(s) described hereinafter.

In the drawings:

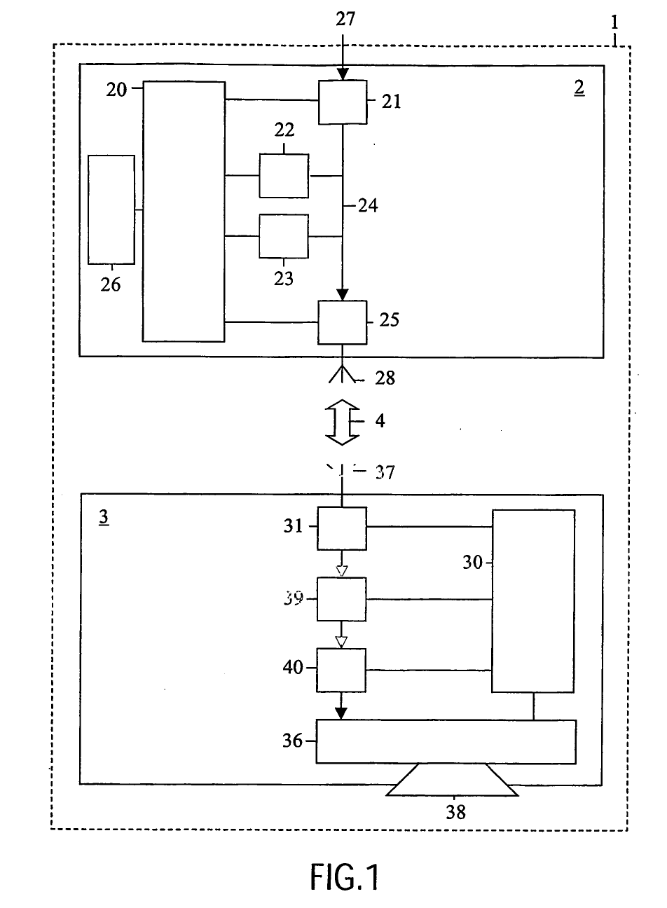

FIG. 1 illustrates in block diagram form a storage device according to the invention coupled to a reproduction device; and

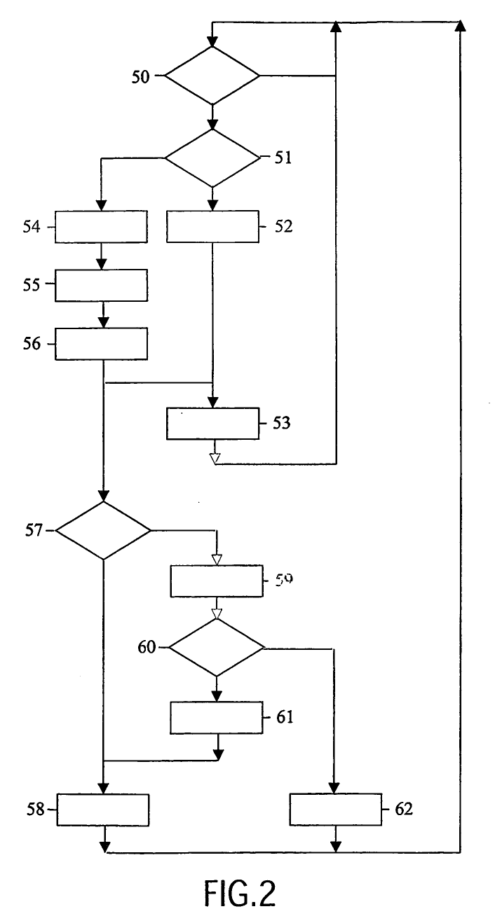

FIG. 2 illustrates in flow chart form steps and/or functions to be performed by the storage device according to the invention.

The storage device 2 according to the invention shown in FIG. 1 like an audio recorder or a hard disk drive recorder forms part of a system 1 according to the invention further comprising a reproduction device 3 like one or more loudspeakers or a wireless or wired headset. The storage device 2 comprises an input interface 21 coupled to an input 27 of the storage device 2 for receiving first data pieces having a first data format for example from the internet. The input interface 21 is further coupled to a processor 20 and via a bus 24 to an channel interface 25. The channel interface 25 is coupled to the processor 20 and to an antenna 28 for communication via a wireless channel 4. The storage device 2 further comprises a transcoder 22 coupled to the processor 20 and to the bus 24, and a storage medium 23 coupled to the processor 20 and to the bus 24. A man-machine-interface (mmi) 26 for example comprising a keyboard, a display etc. is coupled to the processor 20.

The reproduction device 3 comprises an channel interface 31 coupled to an antenna 37 for communication via the wireless channel 4 for receiving second data pieces having a second format. The channel interface 31 is further coupled to a processor 30 and to a converter 39 for converting the second data pieces. The converter 39 is coupled to the processor 30 and to an amplifier 40 for amplifying the converted second data pieces. This amplifier 40 is coupled to the processor 30 and to a man-machine-interface (mmi) 36 for example comprising a keyboard, a display, one or more loudspeakers 38 etc. The mmi 36 is further coupled to the processor 30.

The storage device 2 according to the invention functions as follows. First data pieces having the first data format arrive for example from the internet via the input 27 at input interface 21 for example comprising a modem and/or a filter and/or an amplifier and/or a buffer etc. Thereto, either input 27 is coupled to the internet via for example a personal computer controlled by a user, or input 27 is coupled to the internet more directly via a telephone connection, under control from a user operating mmi 26. The processor 20 is informed of the arrival of the first data pieces, and controls input interface 21 in such a way that the first data pieces are stored via the bus 24 into the storage medium 23 for example comprising a hard disk drive etc.

Then, the user decides to reproduce the recorded data pieces having the first data format at the reproduction device 3 via the channel 4 for example being a Bluetooth channel requiring the data pieces to have a second format different from the first format. The user operates the mmi 26 to search for a predefined data piece. Thereby, either the user has knowledge about the data pieces having different formats and about the second format being required for using the reproduction device 3, or the different formats are hidden to the user, with for example the processor 20 knowing that the reproduction device 3 requires the data pieces to have this second format. In response, the processor 20 for example checks a list of second data pieces stored in storage medium 23. As no second data pieces have been stored so far, a negative search result is generated, and instead of the predefined second data piece, under control of the processor 20 a corresponding first data piece is supplied (copied) from the storage medium 23 via the bus 24 to the transcoder 22 for being transcoded into the predefined second data piece having the second data format. This second data piece is supplied via the bus 24 and the channel interface 25 for example comprising a transmitter and/or an amplifier and/or a filter etc. to the antenna 28.

Via the channel 4, the second data piece arrives via the antenna 37 at the channel interface 31 for example comprising a modem and/or a filter and/or an amplifier and/or a buffer etc. The processor 30 is informed of the arrival of the second data pieces, and controls the channel interface 31, the converter 39 and the amplifier 40 in such a way that the second data pieces are converted and amplified and supplied to mmi 36 for being reproduced via one or more loudspeakers 38.

Alternatively, the user may operate the mmi 36 to, via the processor 30 and the channel 4 to the processor 20, send a request for a search for a predetermined data piece etc.

The transcoding of the corresponding first data piece into the predefined second data piece, which requires much processing capacity and which consumes much power, may be done real time or may be done by (temporarily) storing (a part of) the transcoding result in the storage medium 23. The storage of the transcoding result offers an advantage in that, in case of repeated orders or requests for the same predefined second data piece, this predefined second data piece is already available and does not need to be generated by transcoding the corresponding first data piece again. This saves processing capacity and reduces the power consumption, but increases the necessary storage capacity. To prevent that all first data pieces and all second data pieces are stored in parallel, which would require a giant storage capacity, the following mechanism is introduced.

A set of first data pieces, usually comprising all first data pieces, is stored in the storage medium 23. But only a subset of second data pieces, like for example 1% or 10% of the set, is stored in the storage medium 23. Thereto, either at regular time-intervals or when storing a second data piece which has just been generated by transcoding a corresponding first data piece, the amount of storage capacity needed for the entire subset of second data pieces stored in the storage medium 23 is checked. This amount of storage capacity is compared with a fixed value or with a flexible value for example being a function of the amount of storage capacity needed for the entire set of first data pieces stored in the storage medium 23. In case of the comparison result indicating the fixed or flexible value being exceeded, one or more second data pieces are to be deleted. This is done in dependence of a priority list. Thereto, each first or second data piece is given a data piece priority, for example when storing a second data piece in the storage medium 23 after the transcoder 22 has transcoded a corresponding first data piece into the second data piece. Those second data pieces having the lower priorities are then to be deleted. As a result, the second data pieces having the higher priorities are available directly, without any transcoding being necessary, while the second data pieces having the lower priorities are available indirectly through transcoding corresponding first data pieces stored in the storage medium 23. Of course, the data piece priority is to be adapted regularly or in response to a request and in dependence of statistics like for example the number of times a data piece has been requested and/or the time-interval between a previous request and a present request etc.

Alternatively and/or in addition, third data pieces having a third format like for example pictures etc. may further be stored in storage medium 23, with the arrival of new third data pieces having the third format for example also triggering the checking of the amount of storage capacity needed for the entire subset of second data pieces stored in the storage medium and triggering the deleting of one or more second data pieces etc.

The data pieces may be pieces of music, with the first data format corresponding with a first audio standard like for example MP3 (MPEG Audio Layer-3), WAV (wave), WMA (Windows Media Audio) etc. and with the second data format corresponding with a second audio standard like SBC (Sub Band Coding) etc. The first audio standard requires less storage capacity than the second audio standard. The mmi 26 may also be provided with one or more loudspeakers for reproducing the first data pieces, in other words the first pieces of music using the first audio standard.

Alternatively, the data pieces may be pieces of video, with the first data format corresponding with a first video standard and with the second data format corresponding with a second video standard. In that case, the display and the loudspeakers 38 of mmi 36 in reproduction device 3 will be used for reproducing the second data pieces, in other words the second pieces of video using the second video standard. The mmi 26 comprising the display may also be provided with one or more loudspeakers for reproducing the first data pieces, in other words the first pieces of video using the first video standard. A piece of video for example comprises a (part of a) movie or a (part of a) trailer or a (part of a) video clip etc.

A first data piece and a corresponding second data piece or vice versa usually define the same pieces of music or the same pieces of video, but in different formats, in other words the same pieces of music or the same pieces of video but using different standards. Therefore, the list of second data pieces can be combined advantageously with a list of first data pieces by creating a memory having memory fields each comprising four subfields, a first subfield for indicating the data piece like for example a title, a second subfield for indicating the location of the first data piece having the first format, a third subfield for indicating, if present, the location of the second data piece having the second format, and a fourth subfield for indicating the priority. This memory may form part of storage medium 23 or not.

Of course, many alternatives are possible when creating such a memory and when defining the priorities, the way these priorities are to be adapted, the time-interval for checking amounts of storage capacities, the fixed or flexible value etc. without departing from the scope of this invention. Further, storage medium 23 and mmi 26,36 can be of any kind. The first and second data formats do not exclude the use of the third format etc. The transcoder 22 may comprise either one efficient transcoding unit or a separate decoding unit and a separate encoding unit. The set and subset correspond with a larger number and a smaller number. However, it is not to be excluded that for at least one particular second data piece, a corresponding first data piece no longer is present, for example due to the particular second data piece being made unerasable.

In FIG. 2 illustrating in flow chart form some steps and/or some functions to be performed by the storage device 2 according to the invention, the following blocks have the following meaning:

Block 50: Has a request been received for playing a predefined second data piece having a second data format? If yes, goto block 51, if no, wait for a predetermined time-interval and then goto block 50.

Block 51: Has this predefined second data piece already been stored in the storage medium 23? If yes, goto block 52, if no, goto block 54.

Block 52: Retrieve (copy) the predefined second data piece from the storage medium 23, goto block 53.

Block 53: Supply the predefined second data piece to reproduction device 3, goto block 50.

Block 54: Retrieve (copy) a corresponding first data piece having a first format from the storage medium 23, goto block 55.

Block 55: Decode the corresponding first data piece into an intermediate data piece, goto block 56.

Block 56: Encode the intermediate data piece into the predefined second data piece, goto block 53 for reproducing the predefined second data piece and to block 57 for storing the predefined second data piece.

Block 57: Is there still storage capacity in storage medium 23 for storing the predefined second data piece in addition to the old second data pieces already stored? (to be determined by for example comparing the storage capacity needed for the old second data pieces already stored with the fixed or flexible value) If yes, goto block 58, if no, goto block 59.

Block 58: Store the predefined second data piece in storage medium 23, goto block 50.

Block 59: Retrieve data piece priorities for the old second data pieces already stored, goto block 60.

Block 60: Are one or more of the old second data pieces already stored in the storage medium 23 allowed to be deleted? (to be determined by comparing the priorities of the old second data pieces already stored in the storage medium 23 with each other and/or with a predefined value) If yes, select one or more old second data pieces already stored which are allowed to be deleted, and goto block 61, otherwise goto block 62.

Block 61: Delete the selected one or more old second data pieces, goto block 58.

Block 62: Do not store the predefined second data piece, goto block 50.

A method (processor program product) for supplying data pieces to a reproduction device comprises steps (functions) of receiving first data pieces having a first data format, transcoding a first data piece into a second data piece having a second data format different from the first data format, storing a set of first data pieces and a subset of second data pieces in a storage medium, and searching the storage medium for a predefined second data piece for, in response to a positive search result, supplying the predefined second data piece to the reproduction device and for, in response to a negative search result, transcoding a corresponding first data piece into the predefined second data piece and supplying the predefined second data piece to the reproduction device. Thereby, each block 50-62 may form a substep (subfunction) of the above identified steps (functions).

Of course, many alternatives are possible without departing from the scope of this invention. For example, when comparing priorities for deleting one or more of the old second data pieces already stored in the storage medium 23, the priority of the new, predefined second data piece may be included or not. And instead of using one storage medium 23, for example two or three storage mediums may be used for separately storing the first data pieces, the second data pieces, and the list with their locations and priorities etc., like for example a memory stick for the first data pieces and a hard disk drive for the second data pieces. Therefore, storage medium 23 may comprise one or more storage mediums. In case of a removable storage medium, upon detection of for example a memory stick (comprising a set of first data pieces) being inserted into the storage device 2, the processor 20 may order the transcoding of the most popular first data pieces into the subset of second data pieces, without any interaction from the user etc., and store the subset of second data pieces in the memory stick also or alternatively in a hard disk drive etc. For example substeps (subfunctions) 59-61 may alternatively and/or in addition be triggered by the arrival of new third data pieces having the third format like for example pictures etc. also to be stored in the storage medium 23 etc.

The expression “for” in for example “for A” and “for B” does not exclude that other functions “for C” are performed as well, simultaneously or not. The expressions “X coupled to Y” and “a coupling between X and Y” and “coupling/couples X and Y” etc. do not exclude that an element Z is in between X and Y.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention is based upon an insight, inter alia, that non-transcoder technology requires relatively large amounts of storage capacity and transcoder technology requires relatively much processing capacity and consumes relatively much power, and is based upon a basic idea, inter alia, that all second data pieces do not need to be stored in the storage medium, just a set of first data pieces and a subset of second data pieces are to be stored, with the processor searching for a predefined second data piece and in case of not having found it activating the transcoder for transcoding a corresponding first data piece into this predefined second data piece.

The invention solves the problem, inter alia, of providing a storage device which uses its storage capacity as well as its processing capacity relatively efficient, and is advantageous, inter alia, in that it has an increased battery life time compared to prior art devices using transcoders all the time, and in that it requires less storage capacity compared to prior art devices storing all first and second data pieces in parallel. Further, the storage device according to the invention offers an efficient audio interface between for example the internet and channels requiring a non-internet data format.

1. A storage device (2) for storing data pieces and comprising:
an input (27) for receiving first data pieces having a first data format;
a transcoder (22) for transcoding a first data piece into a second data piece having a second data format different from the first data format;
a storage medium (23) for storing a set of first data pieces and a subset of second data pieces; and
a processor (20) for searching for a predefined second data piece stored in the storage medium (23) and for, in response to a positive search result, supplying the predefined second data piece to a reproduction device (3) and for, in response to a negative search result, controlling the transcoder (22) for transcoding a corresponding first data piece into the predefined second data piece and supplying the predefined second data piece to the reproduction device (3).

2. A storage device (2) as claimed in claim 1, wherein the processor (20) is arranged to delete second data pieces stored in the storage medium in dependence of data piece priorities.

3. A storage device (2) as, claimed in claim 1, wherein the data pieces are pieces of music, with the first data format corresponding with a first audio standard and with the second data format corresponding with a second audio standard, which first audio standard requires less storage capacity than the second audio standard.

4. A storage device (2) as claimed in claim 1, wherein the reproduction device (3) is coupled to the storage device (2) via a wireless channel (4) requiring data pieces to have the second data format.

5. A storage device (2) as claimed in claim 1, wherein the storage device (2) comprises an audio recorder and the reproduction device (3) comprises one or more loudspeakers.

6. A system (1) comprising a reproduction device (3) and a storage device (2) for storing data pieces and comprising:
an input (27) for receiving first data pieces having a first data format;
a transcoder (22) for transcoding a first data piece into a second data piece having a second data format different from the first data format;
a storage medium (23) for storing a set of first data pieces and a subset of second data pieces; and
a processor (20) for searching for a predefined second data piece stored in the storage medium (23) and for, in response to a positive search result, supplying the predefined second data piece to the reproduction device (3) and for, in response to a negative search result, controlling the transcoder (22) for transcoding a corresponding first data piece into the predefined second data piece and supplying the predefined second data piece to the reproduction device (3).

7. A processor (20) for use in a storage device for storing data pieces, which storage device comprises:
an input (27) for receiving first data pieces having a first data format;
a transcoder (22) for transcoding a first data piece into a second data piece having a second data format different from the first data format;
a storage medium (23) for storing a set of first data pieces and a subset of second data pieces; and
the processor (20) for searching for a predefined second data piece stored in the storage medium (23) and for, in response to a positive search result, supplying the predefined second data piece to a reproduction device (3) and for, in response to a negative search result, controlling the transcoder (22) for transcoding a corresponding first data piece into the predefined second data piece and supplying the predefined second data piece to the reproduction device (3).

8. A method for supplying data pieces to a reproduction device (3) and comprising the steps of:
receiving first data pieces having a first data format;
transcoding a first data piece into a second data piece having a second data format different from the first data format;
storing a set of first data pieces and a subset of second data pieces in a storage medium (23); and
searching the storage medium (23) for a predefined second data piece for, in response to a positive search result, supplying the predefined second data piece to the reproduction device (3) and for, in response to a negative search result, transcoding a corresponding first data piece into the predefined second data piece and supplying the predefined second data piece to the reproduction device (3).

9. A processor program product for supplying data pieces to a reproduction device (3) and comprising the functions of:
receiving first data pieces having a first data format;
transcoding a first data piece into a second data piece having a second data format different from the first data format;
storing a set of first data pieces and a subset of second data pieces in a storage medium (23); and
searching the storage medium (23) for a predefined second data piece for, in response to a positive search result, supplying the predefined second data piece to the reproduction device (3) and for, in response to a negative search result, transcoding a corresponding first data piece into the predefined second data piece and supplying the predefined second data piece to the reproduction device (3).
